(19) United States
(12) Patent Application Publication
(10) Pub. No.: US 2015/0074251 A1
(43) Pub. Date: Mar. 12, 2015

(54) COMPUTER SYSTEM, RESOURCE MANAGEMENT METHOD, AND MANAGEMENT COMPUTER

(71) Applicants: Takashi Tameshige, Tokyo (JP); Masaaki Iwasaki, Tokyo (JP); Yutaka Kudo, Tokyo (JP)

(72) Inventors: Takashi Tameshige, Tokyo (JP); Masaaki Iwasaki, Tokyo (JP); Yutaka Kudo, Tokyo (JP)

(73) Assignee: HITACHI, LTD., Tokyo (JP)

(21) Appl. No.: 14/394,453

(22) PCT Filed: Apr. 16, 2012
(86) PCT No.: PCT/JP2012/060264

§ 371 Date: Oct. 14, 2014

(51) Int. Cl. H04L 12/24

(52) U.S. Cl. CPC H04L 41/5025; H04L 41/5009; H04L 41/0813
USPC 709/221; 709/224

(57) ABSTRACT

A computer system, comprising: at least one computer; at least one network apparatus; at least one storage apparatus; and a plurality of service systems for use in execution of given services, the at least one computer including a system control part for managing the plurality of service systems, the system control part being configured to: hold system configuration information and evaluation information; obtain configuration information of the plurality of service systems from the system configuration information, in a case of evaluating the reliability of the plurality of service systems in the services; calculate the evaluation values of the plurality of service systems; and generate information that indicates the reliability of the plurality of service systems based on the calculated evaluation values.

### BACKGROUND OF THE INVENTION

This invention relates to a system, a method, and an apparatus that are used in a management subject system where a plurality of computer systems are built to hierarchically present the reliability of the computer systems.

It is necessary in resource management and infrastructure management to allocate resources in a manner appropriate for the use. “Appropriate” allocation means providing a quality and agility that match the price paid by an end user. A resource administrator therefore needs to keep information for determining whether a computer system is capable of meeting a user's request. Grasping this information is difficult in a large-scale system environment where a diversity of IT equipment and middleware is used mixedly.

A method of evaluating the qualities of computer systems and classifying the computer systems by their reliability levels, and a method of migrating resources between computer systems of different reliability levels are being sought.

### SUMMARY OF THE INVENTION

Resource administrators have hitherto manually determined whether or not a computer system that satisfies reliability demanded by a user can be built based on configuration information of computer systems and connection information which indicates the coupling relationship between components (see, for example, JP 2011-018198 A).

JP 2011-018198 A describes that a management server holds configuration information of functions of heterogeneous resources and configures resource functions to functional requirements, and the management server allocate resources that match a user's request in a computer system pooled resources are not homogeneous.

The technology of JP 2011-018198 A, however, is not capable of optimizing the count of computer systems whose reliability meets the user's demand by presenting computer system reliability that is demanded by the user and changing the computer system configuration as needed.

The present invention can be appreciated by the description which follows in conjunction with the following figures, wherein: a computer system, comprising: at least one computer; at least one network apparatus; at least one storage apparatus; and a plurality of service systems for use in execution of given services. The at least one computer includes at least one first processor, a first memory coupled to the at least one first processor, and a plurality of first I/O devices coupled to the at least one first processor. The at least one storage apparatus includes a second memory, at least one storage medium, and at least one second I/O device for coupled to another apparatus. The at least one network apparatus includes a third memory and at least one port for coupling to another apparatus. The at least one computer further includes a system control part for managing the plurality of service systems. The system control part being configured to: hold system configuration information for managing configurations of the plurality of service systems, and evaluation information for managing evaluation values that indicate reliability of the plurality of service systems in the services; obtain configuration information of the service systems from the system configuration information in a case of evaluating the reliability of the service systems in the services; calculate the evaluation values of the service systems based on the obtained configuration information of the service systems and the evaluation information; and generate information that indicates the reliability of the service systems based on the calculated evaluation values.

According to one embodiment of this invention, the reliability of a service system in a service can be evaluated as a numerical value, thereby facilitating the determination of the reliability of a service system.

### BRIEF DESCRIPTION OF THE DRAWINGS

The present invention can be appreciated by the description which follows in conjunction with the following figures, wherein:

FIG. 1 is an explanatory diagram illustrating an example of the configuration of a management subject system according to a first embodiment of this invention,

FIG. 2 is a block diagram illustrating the configuration of a management server according to the first embodiment of this invention

FIG. 3 is a block diagram illustrating the configuration of a server according to the first embodiment of this invention,

FIG. 4 is a block diagram illustrating a configuration example of virtual servers that run on each server according to the first embodiment of this invention,

FIGS. 5A and 5B are explanatory diagrams outlining the first embodiment of this invention,

FIG. 6 is an explanatory diagram showing an example of system management information according to the first embodiment of this invention,

FIGS. 7A and 7B are explanatory diagrams showing an example of system configuration information according to the first embodiment of this invention,

FIG. 8 is an explanatory diagram showing an example of connection relationship evaluation information according to the first embodiment of this invention,

FIG. 9 is an explanatory diagram showing an example of configuration requirement information according to the first embodiment of this invention,

FIG. 10 is an explanatory diagram showing an example of service management information according to the first embodiment of this invention,

FIG. 11 is a flow chart illustrating processing that is executed by control part according to the first embodiment of this invention,

FIG. 12 is a flow chart illustrating processing that is executed by a reliability determining part according to the first embodiment of this invention,

FIG. 13 is a flow chart illustrating processing that is executed by a configuration determining part according to the first embodiment of this invention,

FIG. 14 is a flow chart illustrating processing that is executed by a configuration changing part according to the first embodiment of this invention,

FIG. 15 is a flow chart illustrating processing that is executed by an evaluation value changing part according to the first embodiment of this invention, and

FIG. 16 is an explanatory diagram illustrating an example of a resource management screen according to the first embodiment of this invention.

### DETAILED DESCRIPTION OF THE PREFERRED EMBODIMENTS

### First Embodiment

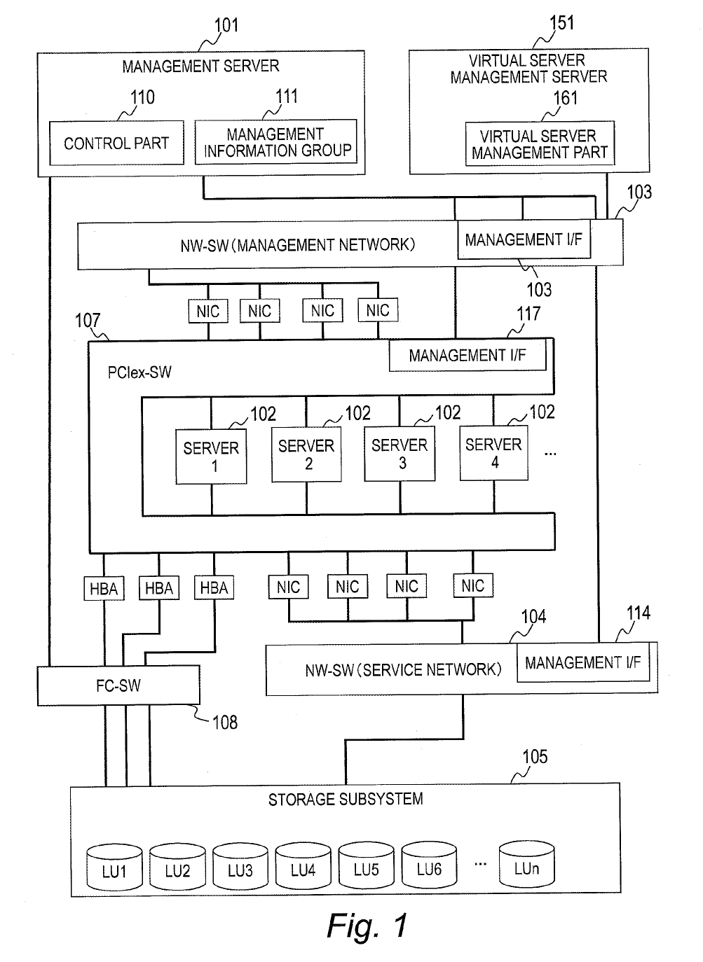

FIG. 1 is an explanatory diagram illustrating an example of the configuration of a management subject system according to a first embodiment of this invention.

The management subject system according to the first embodiment includes a plurality of computer systems. The computer systems include a management server 101, servers 102, a virtual server management server 151, a storage subsystem 105, a network switch for management (NW-SW) 103 and a network switch for service (NW-SW) 104, and a fiber channel switch (FC-SW) 108.

The management server 101 manages the group of computer systems included in the management subject system. The management server 101 is coupled via the NW-SW 103 to a management interface (management I/F) 113 of the NW-SW 103, and to a management interface 114 of the NW-SW 104. The management server 101 can set a virtual LAN (VLAN) for each of the NW-SWs 103 and 104.

To the NW-SW 103, in addition to the management server 101 and the servers 102, the virtual server management server 151 for managing virtual servers (virtual machines) running on the servers 102 is coupled.

The NW-SW 103 constructs a network for management. The network for management is a network used by the management server 101 to manage operations such as distribution of an OS and applications running on the plurality of physical servers 102 and power supply control.

The NW-SW 104 constructs a network for service. The network for service is a network used by applications that are executed by virtual servers on the servers 102. The NW-SW 104 is coupled to a WAN or the like to communicate to/from client computers outside a virtual computer system.

The management server 101 is coupled via the FC-SW 108 to the storage subsystem 105. The management server 101 manages logical units (LUs) in the storage subsystem 105. In the example illustrated in FIG. 1, the management server 101 manages N LUs, namely, an LU1 to an LUn.

On the management server 101, a control part 110 for managing resources included in the computer systems such as the servers 102 is executed. The control part 110 refers to and updates a management information group 111. The management information group 111 is updated by the control part 110 in given cycles.

The servers 102 included in the management subject system provide virtual servers as described later. The servers 102 are coupled via a PCIex-SW 107 and I/O devices to the NW-SWs 103 and 104.

To the PCIex-SW 107, the I/O devices compliant with the PCI Express standard are coupled. The I/O devices include I/O adapters such as network interface cards (NICs), host bus adapters (HBAs), and converged network adapters (CNAs).

In general, the PCIex-SW 107 is an I/O switch for extending a bus of the PCI Express out from a mother board (or server blade) to couple more PCI-Express devices. It should be noted that a system configuration in which the servers 102 are directly coupled to the NW-SWs 103 and 104 without the intermediation of the PCIex-SW 107 may be employed.

The management server 101 is coupled to a management interface 117 of the PCIex-SW 107 to manage coupling relationships between the plurality of servers 102 and the I/O devices. The server 102 makes an access via the I/O devices (in FIG. 1, HBAs) coupled to the PCIex-SW 107 to the LU1 to LUn of the storage subsystem 105.

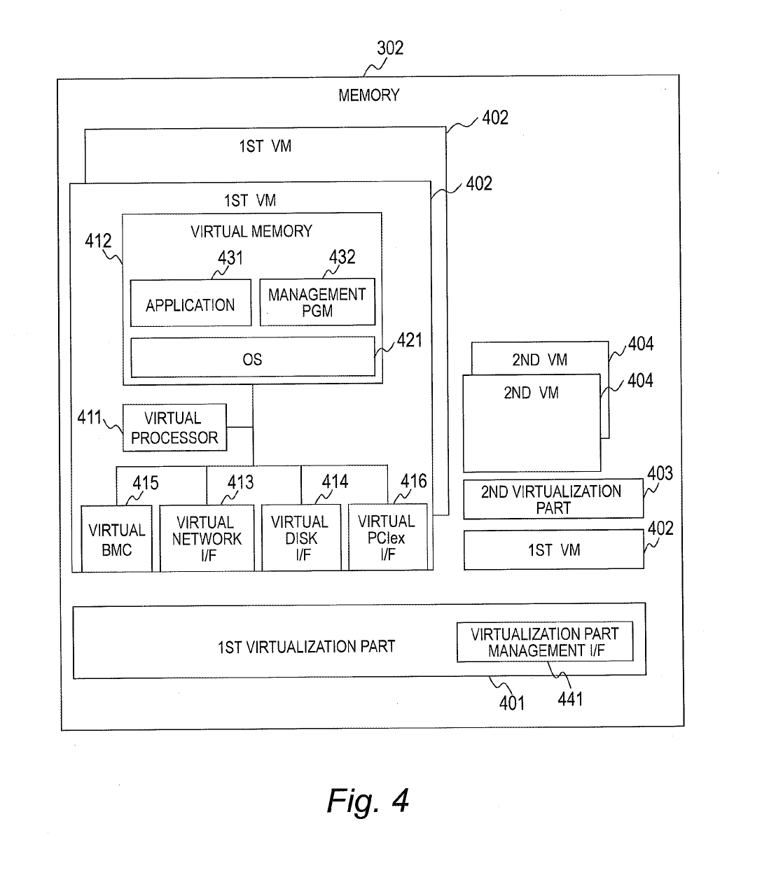

The virtual server management server 151 manages a first virtualization part 401 illustrated in FIG. 4 and second virtual servers 404 illustrated in FIG. 4, which are executed on each of the servers 102. Specifically, a virtual server management part 161 issues instructions to the first virtualization part 401.

For example, the virtual server management part 161 issues an instruction to execute power supply control for the second virtual servers 404 and an instruction to execute migration of the second virtual servers 404 and the first virtualization part 401. The management server 101 may include the virtualization server management part 161.

In this embodiment, the servers 102, the I/O devices, the NW-SW 104, the storage subsystem 105, the FC-SW 108, and others are used to build a plurality of computer systems having given functions.

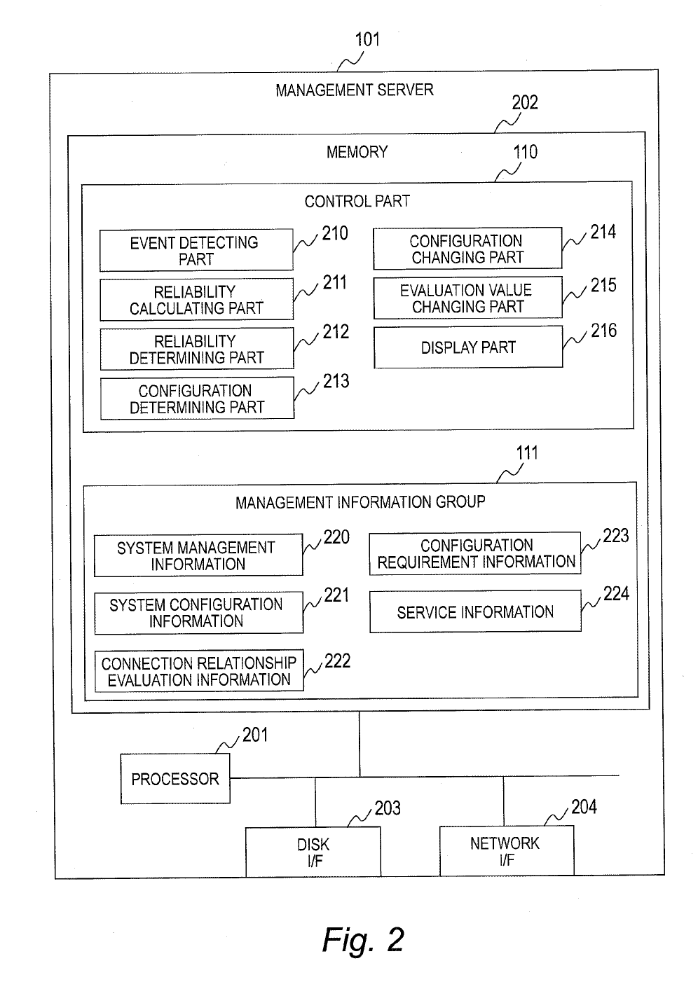

FIG. 2 is a block diagram illustrating the configuration of the management server 101 according to the first embodiment of this invention.

The management server 101 includes a processor 201, a memory 202, a disk interface 203, and a network interface 204.

The processor 201 executes programs stored in the memory 202. The memory 202 stores a program executed by the processor 201 and information necessary to execute the program. What programs and information are stored in the memory 202 is described later.

The disk interface 203 is an interface for accessing the storage subsystem 105. The network interface 204 is an interface for holding communication to and from other apparatus over an IP network.

Though not shown in FIG. 2, the management server 101 may include a basement management controller (BMC) for controlling power supply and controlling the interfaces, and a PCI-Express interface for coupling to the PCIex-SW 107.

The memory 202 stores a program that implements the control part 110 and the management information group 111. The control part 110 is constructed of a plurality of program modules and provides functions for performing various types of control. Specifically, the control part 110 includes an event detecting part 210, a reliability calculating part 211, a reliability determining part 212, a configuration determining part 213, a configuration changing part 214, an evaluation value changing part 215, and a display part 216.

The event detecting part 210 detects various events. For instance, the event detecting part 210 detects, as events, migration, power management, a failure in one of the servers 102, and a request to change settings. The event detecting part 210 calls up one of functional parts described later that is relevant to the detected event.

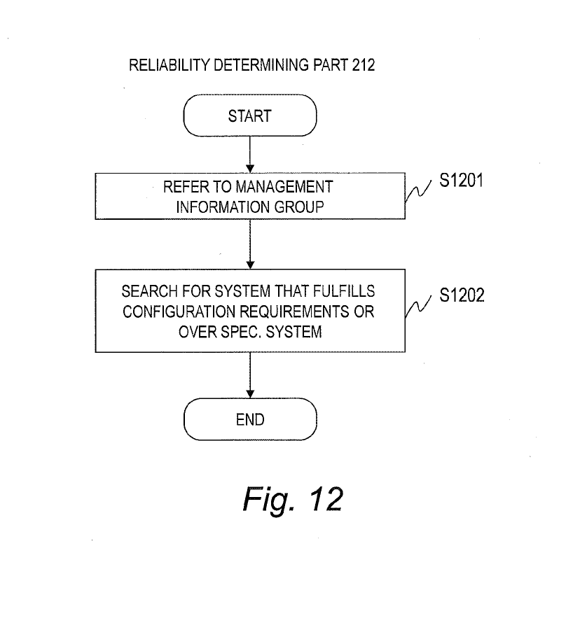

The reliability calculating part 211 calculates a value that indicates the reliability of a computer system. The value indicating the reliability of a computer system is hereinafter also referred to as evaluation value. The reliability determining part 212 determines whether or not a computer system fulfills a given requirement based on an evaluation value calculated by the reliability calculating part 211. Details of the processing that is executed by the reliability determining part 212 are described later with reference to FIG. 12.

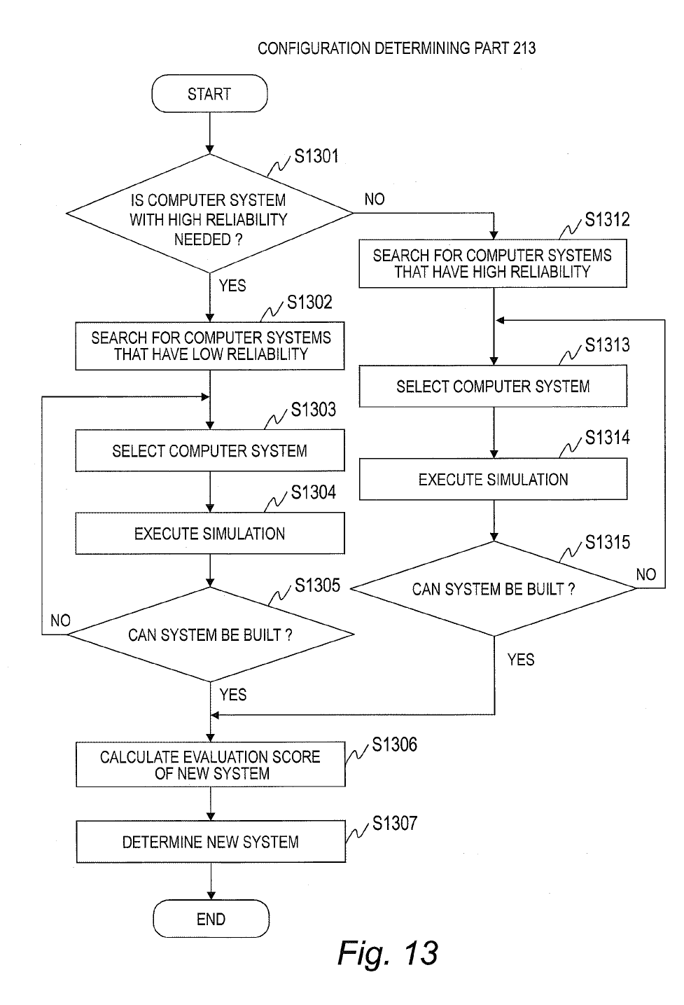

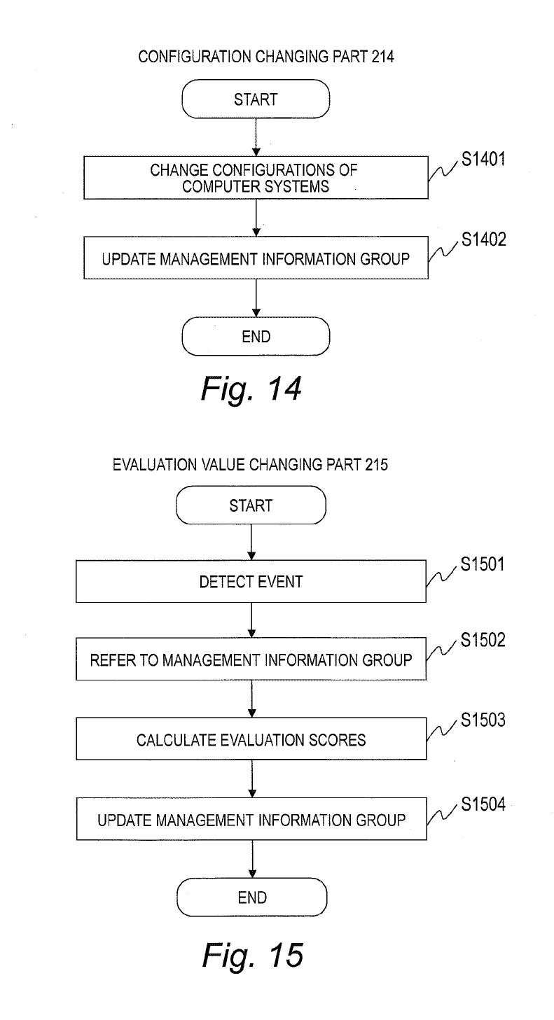

The configuration determining part 213 determines whether or not a computer system that fulfills a given requirement can be built. Details of the processing that is executed by the configuration determining part 213 are described later with reference to FIG. 13. The configuration changing part 214 changes the current computer system configuration in order to build a computer system determined as buildable by the configuration determining part 213. Details of the processing that is executed by the configuration changing part 214 are described later with reference to FIG. 14.

The evaluation value changing part 215 changes an evaluation value. Details of the processing that is executed by the evaluation value changing part 215 are described later with reference to FIG. 15. The display part 216 displays the results of various types of processing.

The processor 201 loads the functional parts, which are the event detecting part 210, the reliability calculating part 211, the reliability determining part 212, the configuration determining part 213, the configuration changing part 214, the evaluation value changing part 215, and the display part 216, onto the memory 202 as programs, and executes the loaded programs.

The processor 201 operates as programmed by the programs of the functional parts, thereby operating as functional parts for implementing given functions. For instance, the processor functions as the reliability calculating part 211 by operating as programmed by the program that implements the reliability calculating part 211. The same applies to the rest of the programs. The processor 201 also operates as functional parts that respectively implement a plurality of processing procedures executed by the respective programs.

The management information group 111 stores various types of information for managing the computer systems. Specifically, the management information group 111 includes system management information 220, system configuration information 221, connection relationship evaluation information 222, configuration requirement information 223, and service management information 224.

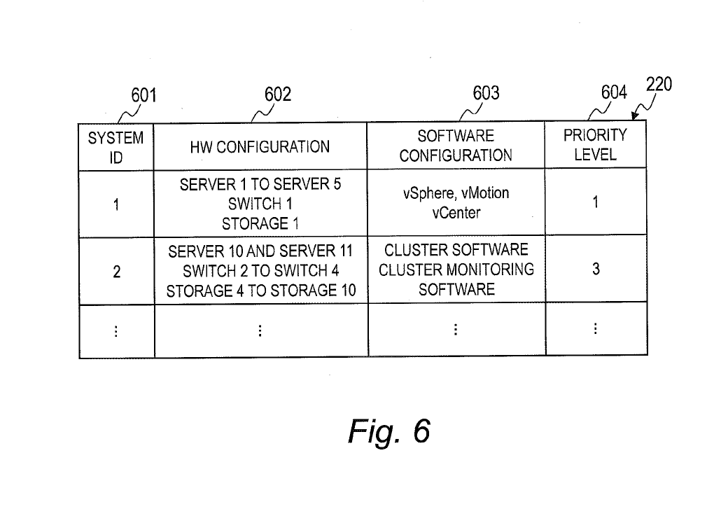

Stored as the system management information 220, for every computer system included in the management subject system, is information for managing the system configuration of the computer system. Details of the system management information 220 are described later with reference to FIG. 6.

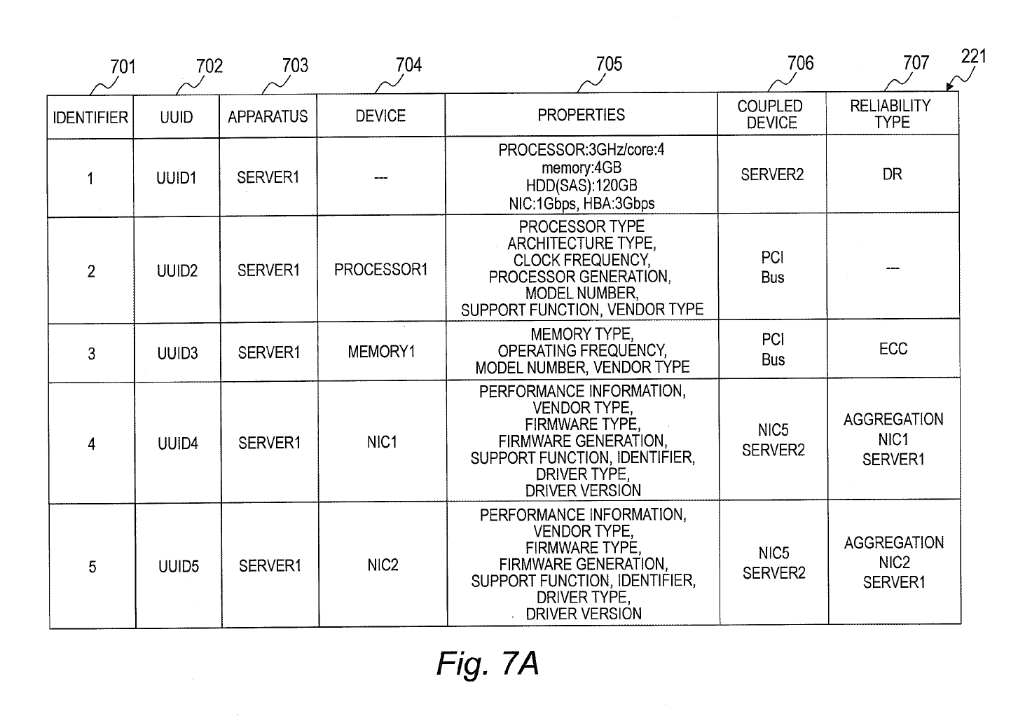

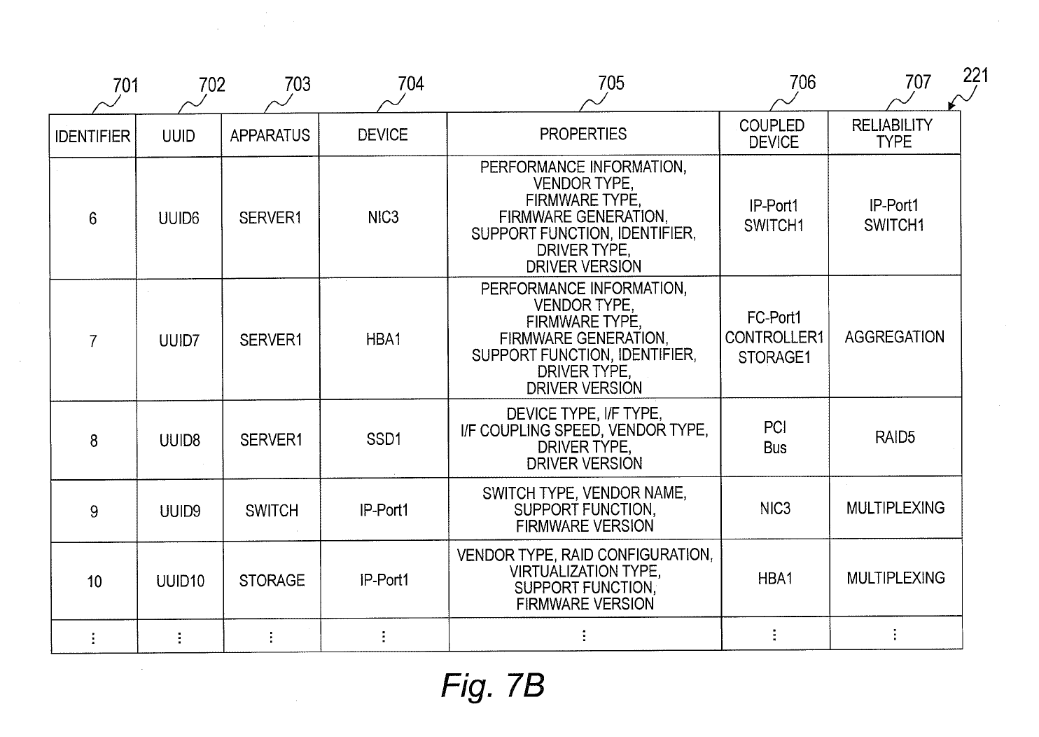

Stored as the system configuration information 221 is information for managing the detailed configurations of the respective computer systems. Details of the system configuration information 221 are described later with reference to FIGS. 7A and 7B.

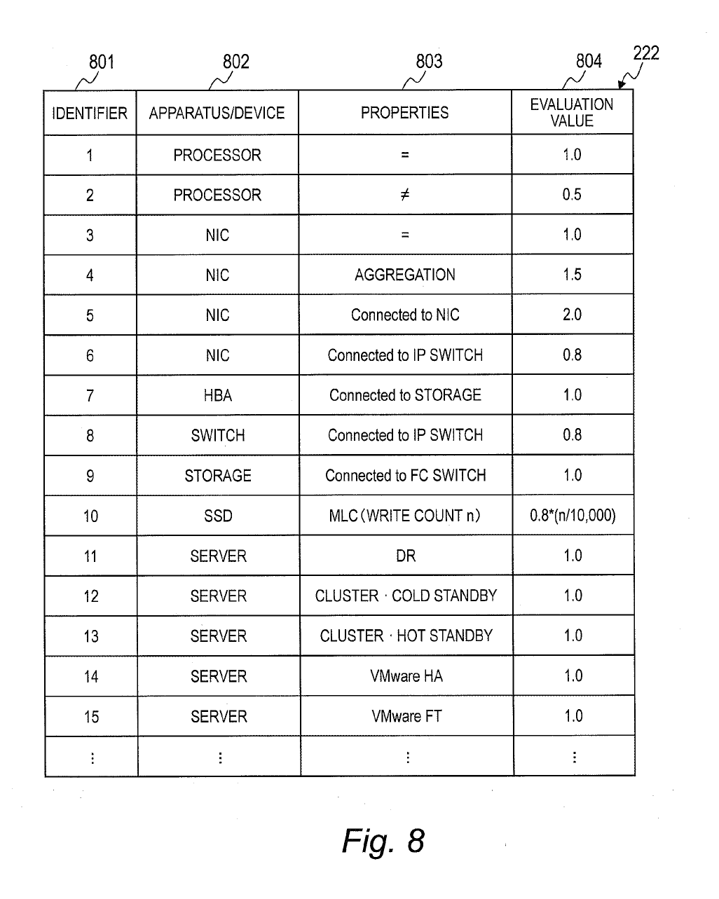

Stored as the connection relationship evaluation information 222 is information about a reference for determining the reliability of a computer system and the reliability in a connection relationship between components of a computer system. Details of the connection relationship evaluation information 222 are described later with reference to FIG. 8.

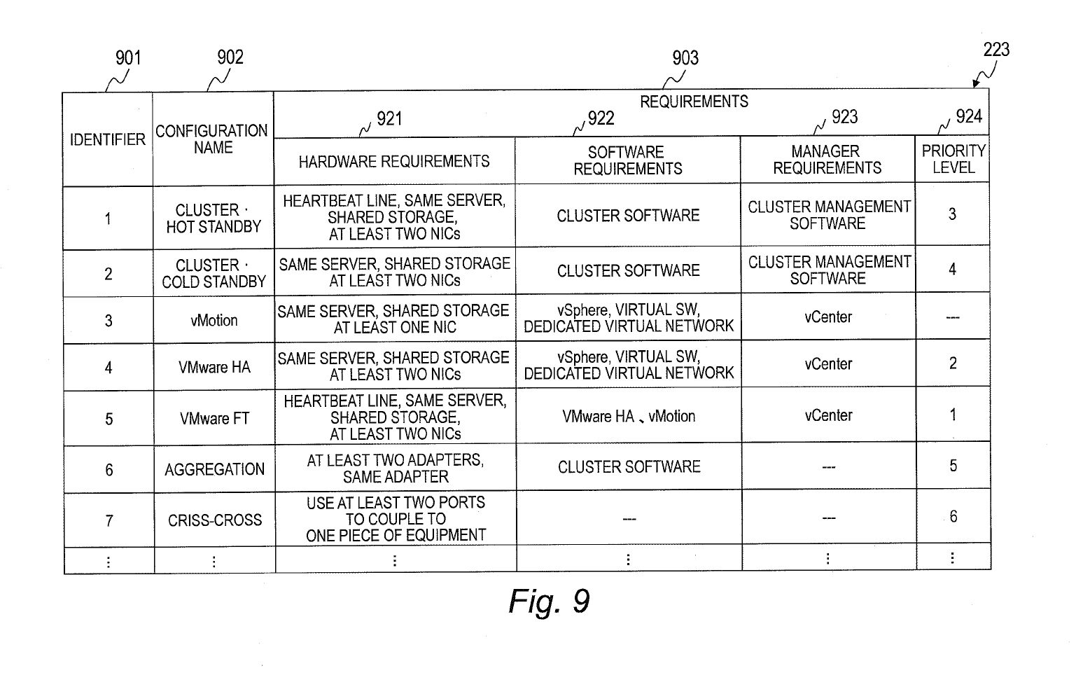

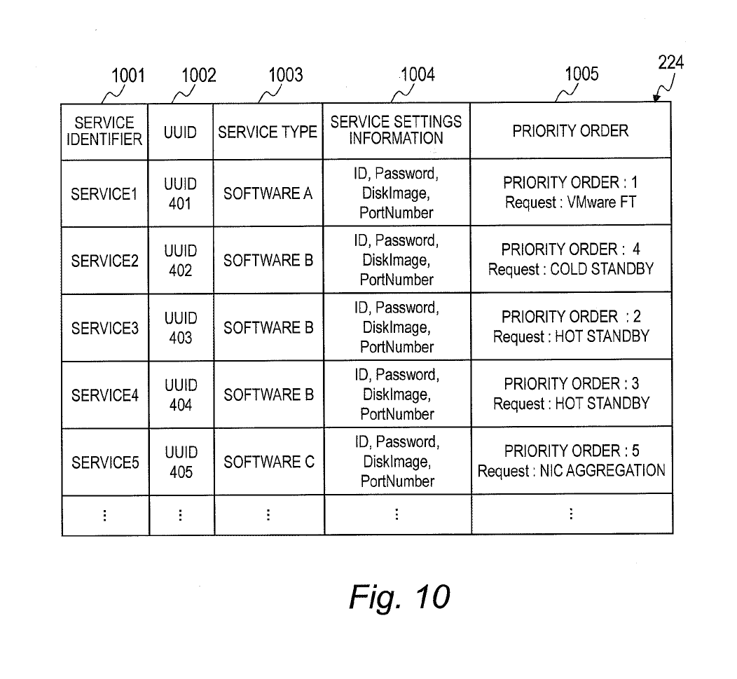

Stored as the configuration requirement information 223 is information about a computer system configuration requested by a user. Details of the configuration requirement information 223 are described later with reference to FIG. 9. Stored as the service management information 224 is information about services provided with the use of the respective computer systems. Details of the service management information 224 are described later with reference to FIG. 10.

Information to be stored in the management information group 111 may be collected automatically by using a standard interface or an information collection program, or may be input from a console (not shown) of the management server 101 by a system administrator or the like.

The management server 110 may store information in which the system management information 220 and the system configuration information 221 are integrated. The control part 110 may hold the pieces of information included in the management information group 111.

The server type of the management server 101 may be any one of a physical server, a blade server, a virtualized server, and a logically or physically divided server, and effects of this invention can be provided by using any one of the servers.

Information such as programs for implementing each of the functions of the control part 110 and management information can be stored in memory devices such as the storage subsystem 105, a non-volatile semiconductor memory, a hard disk drive, and a solid state drive (SSD), or in a computer-readable non-transitory data storage medium such as an IC card, an SD card, and a DVD.

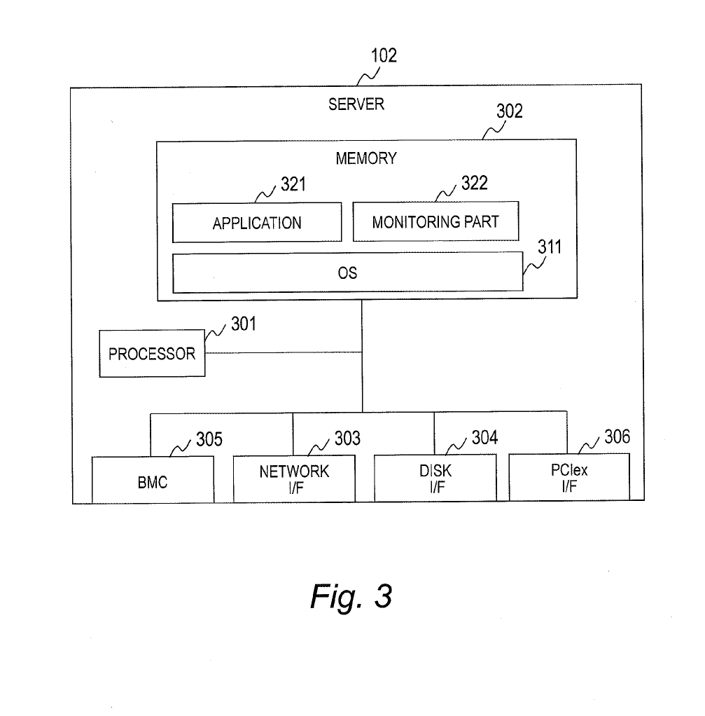

FIG. 3 is a block diagram illustrating the configuration of the server 102 according to the first embodiment of this invention.

The server 102 includes a processor 301, a memory 302, a network interface 303, a disk interface 304, a BMC 305, and a PCI-Express interface 306.

The processor 301 executes programs stored in the memory 302. The memory 302 stores a program executed by the processor 301 and information necessary to execute the program. What programs and information are stored in the memory 302 is described later.

The network interface 303 is an interface for holding communication to and from other apparatus over an IP network. The disk interface 304 is an interface for accessing the storage subsystem 105.

The BMC 305 controls power supply and controls the interfaces. The PCI-Express interface 306 is an interface for coupling to the PCIex-SW 107.

The memory 302 stores programs that implement an OS 311, an application 321, and a monitoring part 322. The processor 301 executes the OS 311 in the memory 302, thereby managing devices in the server 102. The application 321 which provides a service and the monitoring part 322 operate under the OS 311.

The memory 302 may store a program that implements a virtualization part for managing virtual servers as described later.

While the example of FIG. 3 illustrates one network interface 303, one disk interface 304, and one PCI-Express interface 306, the server 102 may have a plurality of network interfaces, a plurality of disk interfaces, and a plurality of PCI-Express interfaces. For instance, the server 102 may have a network interface that couples to the NW-SW 103 and a network interface that couples to the NW-SW 104.

FIG. 4 is a block diagram illustrating a configuration example of virtual servers that run on each server 102 according to the first embodiment of this invention. The physical configuration of each server 102 is the same as the one illustrated in FIG. 3, and is therefore omitted here.

The server 102 of FIG. 4 is used to construct a multi-stage virtual computer which has the first virtualization part 401 which allocates physical computer resources to a plurality of first virtual servers 402 (or logical partitions), and a second virtualization part 403 which allocates computer resources of one of the plurality of first virtualization servers 402 to a plurality of the second virtual servers 404.

In the memory 302, the first virtualization part 401 for virtualizing computer resources of the server 102 is deployed as a virtualization part of a lower layer to provide computer resources (the first virtual servers 402) to a plurality of second virtualization parts 403, which are virtualization parts of an upper layer. The second virtualization parts 403 generate a plurality of second virtual servers 404 and store the second virtual servers 404 in the memory 302. The first virtualization part 401 has, as a control interface, a virtualization part management interface 441. Though not shown in FIG. 4, the second virtualization parts 403 also have virtualization part management interfaces as control interfaces.

The first virtualization part 401 virtualizes the computer resources of the server 102 (or the blade server) to construct the plurality of first virtual servers 402. As the first virtualization part 401, for example, a hypervisor, a virtual machine monitor (VMM), or the like can be employed. The second virtualization parts 403 further virtualize the computer resources (first virtual servers 402) provided by the first virtualization part 401 to generate the plurality of second virtual servers 404. As the second virtualization part 403, for example, a hypervisor, a VMM, or the like can be employed.

The second virtual servers 404 are constructed by virtual devices (or logical devices) provided by the second virtualization parts 403. The virtual devices of this embodiment include a virtual processor 411, a virtual memory 412, a virtual network interface 413, a virtual disk interface 414, a virtual BMC 415, and a virtual PCIex interface 416.

The above-mentioned logical devices are the computer resources (first virtual servers 402) allocated by the first virtualization part 401 to the plurality of the second virtualization parts 403 and further allocated by the second virtualization parts 403 to each of the second virtual servers 404.

An OS 421 is stored in the virtual memory 412, and the OS 421 manages the virtual devices in the second virtual server 404. Moreover, an application 431 is executed on the OS 421. Moreover, a management program 432 running on the OS 421 provides functions such as failure detection, power supply control by the OS, and inventory management.

The first virtualization part 401 manages association between the physical computer resources of the server 102 and the computer resources allocated to the second virtualization parts 403. This embodiment discusses an example in which the first virtualization part 401 allocates the first virtual servers 402 to the second virtualization parts 403, but the first virtualization part 401 may directly allocate the computer resources of the physical server 102 to the second virtualization parts 403. In this case, the first virtual servers 402 can be omitted.

The first virtualization part 401 can dynamically change the computer resources of the server 102 allocated to the plurality of second virtualization parts 403, and can cancel the allocation of the computer resources. The first virtualization part 401 holds the amounts of the computer resources allocated to the second virtualization parts 403, configuration information, and operation history.

The second virtualization parts 403 further virtualize computer resources of the first virtual servers 402 to allocate the virtualized resources to the plurality of virtual servers (second virtual servers) 404. The second virtualization parts 403 manage association between the second virtual servers 404 and computer resources of the first virtual servers 402 that are allocated to the respective second virtual servers 404. The second virtualization parts 403 can dynamically change computer resources of the first virtual servers 402 to be allocated to the plurality of second virtual servers 404, and can cancel the allocation of the computer resources. The second virtualization parts 403 hold the amounts of computer resources allocated to the second virtual servers 404, configuration information, and operation history.

In this embodiment, the first virtualization part 401 for providing the first virtual servers 402 acquired by virtualizing the hardware of the server 102 is assumed as a first layer, the second virtualization parts 403 for providing the second virtual servers 404 acquired by further virtualizing the computer resources of the first virtual servers 402 are assumed as a second layer, and the OSs 421 are assumed as a third layer. Then, the third layer side is assumed as the upper layer, and the first layer side is assumed as the lower layer. However, in the case where the structure is not multi-layered, the first virtualization part 401 is the first layer and the OS 421 runs on its upper layer.

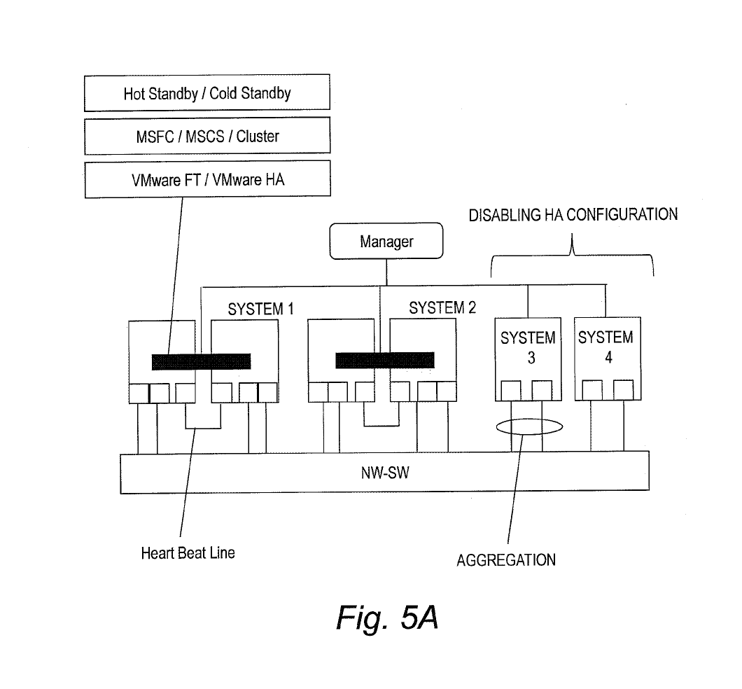

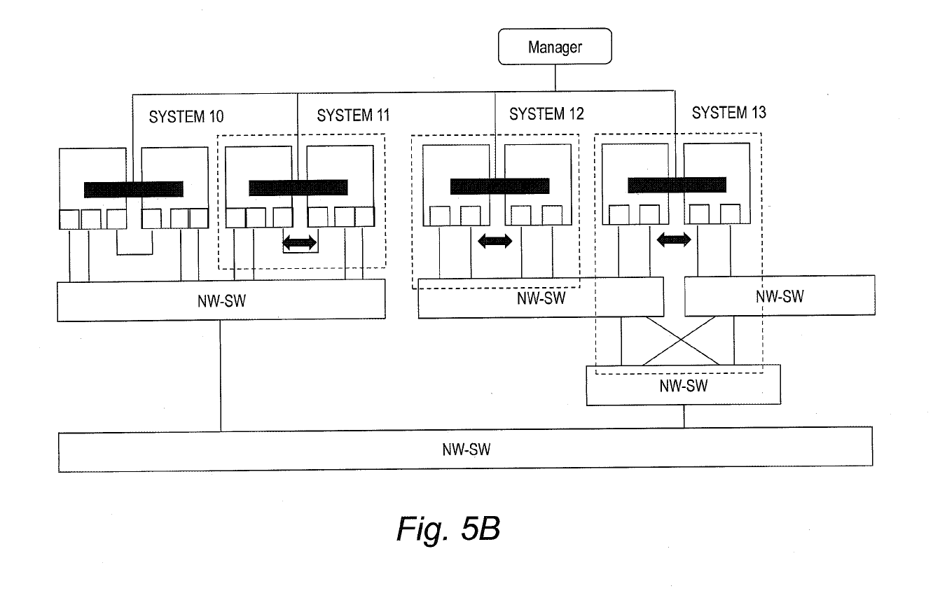

FIGS. 5A and 5B are explanatory diagrams outlining the first embodiment of this invention.

FIG. 5A is a diagram illustrating reliability about the redundancy configurations of computer systems. FIG. 5A illustrates the configurations of computer systems 1 to 4. The computer system 1 and the computer system 2 are computer systems having a redundancy configuration such as VMware FT (VMware is a trademark). In this embodiment, the redundancy configurations of computer systems are managed by assigning each redundancy configuration a reliability rank (priority level).

Even if it is a same redundancy configuration, the reliability of a computer system can be identified for every a method of a redundancy configuration.

The system 3 and the system 4 are created by reconstructing a computer system that has a redundancy configuration as the system 1 and the system 2. Aggregation are set in the NICs of the server 102 that constructs the computer system 3.

The computer system 3 is therefore higher in reliability than the computer system 4. In this embodiment, computer systems that have the same reliability rank can be compared with each other with the use of their evaluation values, aside from the priority levels.

Calculating an evaluation value for each function that a computer system has also makes more detailed comparison possible.

FIG. 5B is a diagram illustrating reliability about functions of computer systems. FIG. 5B illustrates the configurations of computer systems 10 to 13.

In the computer system 10 and the computer system 11, a heartbeat line is connected so that adapters of the servers 102 are connected directly to each other. In the computer system 12, on the other hand, a heartbeat line is connected via one NW-SW. The computer system 10 and the computer system 11 are accordingly higher than the computer system 12, in a case of being evaluated in reliability about the heartbeat function. The computer system 13, where a heartbeat line is connected via two NW-SWs, is lower in reliability than the computer system 12.

In this embodiment, the reliability of one computer system and another computer system which both have the heartbeat function can be evaluated separately in detail and with precision by calculating, as evaluation values, the differences in reliability described above.

This embodiment accomplishes flexible management of the management target system by changing the computer system configuration based on information that indicates system reliability, such as the reliability level and the evaluation value.

Events detected by the event detecting part 210 include a request for resources that is issued by a user, a failure in a computer system, and scheduled maintenance.

In the case where a resource request is detected and there is a shortage of computer systems that have high reliability, the management server 101 determines whether or not computer systems that have a High Availability (HA) configuration can be built through reconstruction, based on the system management information 220, the system configuration information 221, and the connection relationship evaluation information 222. In a case where those computer systems can be built through reconstruction, the management server 101 reconstructs existing computer systems.

In the case where there is a shortage of computer systems that have low reliability, on the other hand, the management server 101 uses existing computer systems as they are, or disables the HA configuration, to secure a necessary count of apparatus and a necessary count of devices. Surplus resources are checked in order to change system counts and device counts that are to be secured for the respective reliability levels based on actual performance and availability status.

In a case where a failure occurs in a computer system, the management server 101 performs recalculation of evaluation scores and a reconfiguration process as needed in order to secure necessary counts of computer systems and devices that have given reliability.

In scheduled maintenance, the management server 101 performs recalculation of evaluation scores and reconfiguration processing as needed in order to secure necessary counts of computer systems and devices that have given reliability. Scheduled maintenance differs from the processing that is executed in the event of a failure in that the execution of processing can be planned in advance.

Additionally introducing a new piece of hardware corresponds to metabolic activity (lifecycle management) of computer systems that triggers the reviewing of evaluation scores by the management server 101. This keeps evaluation score calculation results fresh and prevents evaluation score calculation results from becoming obsolete.

In this embodiment, the computer system configuration is changed to suit a service use in question and a resource request made.

The counts of systems and devices that have given reliability can be adjusted by changing redundancy configurations. For instance, conditions for building a computer system that has the VMware FT configuration are that “VMware HA and vMotion are feasible” and that “at least two physical NICs are provided other than those for management and a service”.

In a case where a resource request related to VMware FT or VMware HA is made, the management server 101 obtains the count of physical NICs from the system management information 220 and the system configuration information 221 to determine whether or not the conditions given above are satisfied. In the case of the VMware FT configuration, the same processing as in the active server is executed in the standby server with a delay of a few seconds at maximum, which means that the distance between the active server and the standby server over the network needs to be close. A computer system having the VMware FT configuration is therefore configured so that the coupling between the active server and the standby server does not include multiple stages of switches.

To change a computer system from which the VMware FT configuration can be built into a VMware HA computer system or a cold standby-use computer system, the management server 101 changes the current configuration into a configuration where the distance is long for a standby server (fewer resources and facilities are shared). This means that recovery takes long but has an effect of being capable of overcoming more points of failure than VMware FT.

The management server 101 preferentially uses a configuration where a heartbeat line is connected directly for VMware FT, VMware HA, and the hot standby use.

In the case where devices that are compatible with a link-down detection (Media Independent Interface) monitoring function and devices that are not compatible with the MII monitoring function are included, the management server 101 meets users' requests by switching between the MII monitoring function and an ARP monitoring function.

The management server 101 secures a necessary count of devices that is needed to meet a user's request by disabling the aggregation settings and thus increasing the count of devices that can be used individually.

A computer system having high reliability can be reconstructed into a plurality of low-reliability systems by disabling the redundancy settings of the high-reliability computer system.

To build a computer system that has high reliability, on the other hand, the management server 101 deploys cluster software, virtualization parts, and the like and sets necessary settings.

In a case of building a high-reliability computer system, the management server 101 checks, for example, whether processors capable of constructing VMware FT can be secured, and whether as many physical NICs as necessary for VMware Fr can be secured. The management server 101 also checks whether a heartbeat line is connected and the distance between the active server and the standby server over the network by checking the count of stages of switches that couple the active server and the standby server. This reduces the chance of packet loss along the heartbeat line and lowers the probability of erroneous detection.

In the case of building a computer system that has a cold standby configuration, the management server 101 checks whether a computer system constructed of the server 102 whose hardware configuration and software configuration are equivalent to those of the computer system to be built can be secured as an auxiliary computer system.

In the case of building a computer system that has an N+M cold standby configuration, the management server 101 can set the count of standby servers to a value less than the count of active servers.

Guaranteeing the reliability of a computer system is accomplished by securing as many standby servers as the count of active servers, or more, and, with the enhanced reliability, a situation where a switched-to standby server goes down soon after failover can be dealt with.

The management server 101 can also evaluate reliability with respect to the storage configuration, and controls the storage configuration by displaying a SAN (HBA), iSCSIs (NICs), FCoE (CNAs), a redundant arrays of independent disks (RAID) configuration, tiering, zone settings that are set in the reconstruction of computer systems, and the like.

Securing reliability is in a trade-off relationship with cost. Therefore, a reliable computer system that is in great demand by users can be run by adjusting the system count and the device count for each reliability level depending on how much is charged.

FIG. 6 is an explanatory diagram showing an example of the system management information 220 according to the first embodiment of this invention.

The system management information 220 stores information for managing the configurations of computer systems in the management subject system that have already been built. Specifically, the system management information 220 includes a system ID 601, an HW configuration 602, a software configuration 603, and a priority level 604.

The system ID 601 is an identifier for identifying a computer system.

Stored as the HW configuration is information about the hardware configuration of the computer system, specifically, the apparatus configuration. For instance, the counts and identification information of the servers 102, the NW-SWs 104, and the storage subsystems 105 that are used in the computer system are stored.

A software configuration introduced in the computer system is stored as the software configuration 603.

A value indicating the reliability of the computer system is stored as the priority level 604. The reliability of a computer system is an indicator that indicates the system's importance level and the degree of influence of the system. In this embodiment, the reliability of a computer system is classified into a rank based on the priority level 604. A computer system that has a smaller value as the priority level 604 is higher in reliability in this embodiment.

FIGS. 7A and 7B are explanatory diagrams showing an example of the system configuration information 221 according to the first embodiment of this invention.

The system configuration information 221 stores information for managing the configurations of apparatus constructing computer systems. Specifically, the system configuration information 221 includes an identifier 701, a universal unique identifier (UUID) 702, an apparatus 703, a device 704, properties 505, a coupled device 706, and a reliability type 707.

Stored as the identifier 701 is an identifier for identifying an entry in the system configuration information 221. Entry identifiers are automatically assigned in ascending order in this embodiment.

The identifier 701 can be omitted by specifying one of the other columns, or a combination of a plurality of columns, in the system configuration information 221.

Stored as the UUID 702 is a UUID, which is an identifier in a format defined so as to avoid duplication. Each server 102 holds a UUID so that server identifiers are guaranteed an absolute uniqueness. The UUID is therefore very effective in server management that covers a wide range.

Using the UUID is desirable but not indispensable because there is no problem in employing as the identifier 701 identifiers that are used by the system administrator to identify the servers 102, as long as identifier duplication is avoided among the servers 102 that are management subjects. For example, the MAC address or the World Wide Name (WWN) can be used for the identifier 701.

Stored as the apparatus 703 is information that indicates the type of an apparatus constructing a computer system. For example, a name that indicates an IT equipment type such as “server”, “storage”, or “network” is stored as the apparatus 703. A facility name such as “power supply apparatus” or “rack” may also be stored.

Stored as the device 704 is information that indicates the type of a device included in the apparatus. For example, in the case where “server” is stored as the apparatus 703, the type of a device that is included in the server, such as the processor 301 and the memory 302, is stored as the device 704. In an entry for an apparatus that corresponds to a computer system itself, such as the servers 102, the device 704 remains blank.

Stored as the properties 705 is information about a subject apparatus or a subject device. Examples of information that can be stored as the properties 705 include types such as “HBA”, “NIC”, and “CNA”, a WWN that is the identifier of the HBA, an MAC address that is the identifier of the NIC, performance information, architecture information, generation information, a model number, a support function, a vendor type, firmware information, driver information, I/F information, switch information, RAID information, a virtualization type, and virtualization association information.

Stored as the coupled device 706 is information about an apparatus or a device to which the subject apparatus or the subject device is coupled. Coupling between an apparatus and a device, coupling between one apparatus and another apparatus, or coupling between devices can thus be determined. For instance, the control part 110 can determine whether or not building a system that uses a directly connected heartbeat line is possible based on the coupled device 706.

Stored as the reliability type 707 is the type of reliability, in other words, information about a function that is implemented by the apparatus or the device. Examples of information that can be stored as the reliability type 707 are given below.

In the case where an apparatus itself is the subject, information that indicates disaster recovery (DR) •fault tolerant (FT) or HA •cluster is stored. “HA •cluster” here means a computer system that has a cluster configuration for hot standby, cold standby, or the like. In the case of cold standby, information for identifying whether the cold standby configuration is a 1:1 configuration or an N+M configuration may be added.

In a case where the subject is a memory, information that indicates the presence or absence of an error check and correct (ECC) function is stored as the reliability type 707. In a case where the subject is an NIC and an HBA, information that indicates the presence or absence of aggregation such as teaming and bonding, and the presence or absence of multiplexing is stored as the reliability type 707. In a case where the subject is a storage apparatus, information that indicates the presence or absence of a RAID configuration in SSDs or HDDs, and information that indicates a RAID level are stored as the reliability type 707.

The pieces of information stored in the respective columns are given as an example, and are not to limit this invention.

FIG. 8 is an explanatory diagram showing an example of the connection relationship evaluation information 222 according to the first embodiment of this invention.

The connection relationship evaluation information 222 stores an evaluation value for each apparatus/device performance or configuration. Specifically, the connection relationship evaluation information 222 includes an identifier 801, an apparatus/device 802, properties 803, and an evaluation value 804.

Stored as the identifier 801 is an identifier for identifying an entry in the connection relationship evaluation information 222.

The type of an evaluation subject apparatus or an evaluation subject device is stored as the apparatus/device 802. For example, a name that indicates an IT equipment type such as “server”, “storage”, or “network” is stored as the apparatus type. A facility type such as “power supply apparatus” and “rack” may also be stored as the apparatus/device 802. A name that indicates a device type such as “processor”, “memory”, “NIC”, “HBA”, “HDD (SAS or SATA)”, or “SSD” is stored as the device type.

The control part 110 can use the apparatus/device 802 to search for a device that is coupled via multiple stages of switches.

Stored as the properties 803 is information that serves as an indicator of the reliability of an apparatus or a device that corresponds to the apparatus/device 802 in terms of performance, coupling relationship, function, and the like.

The evaluation value of the apparatus or device corresponding to the apparatus/device 802 is stored as the evaluation value 804. A predetermined value is stored as the evaluation value 804 in this embodiment. The evaluation value 804, however, can be changed as described later.

In the example of FIG. 8, an entry where the identifier 801 is “4” shows that, the subject is an NIC and in a case where aggregation is set in the NIC, the subject has an evaluation value “1.5”. An entry where the identifier 801 is “5” shows that, the subject is an NIC and in a case where the NIC is connected directly to another NIC, the subject has an evaluation value “2.0”. An entry where the identifier 801 is “6” shows that, the subject is an NIC and in a case where the NIC is coupled to an IP switch, the subject has an evaluation value “0.8”. An entry where the identifier 801 is “1” shows that, the subject is a processor and in a case where the processors 301 of at least two servers 102 have the same performance, the subject has an evaluation value “1.0”.

FIG. 9 is an explanatory diagram showing an example of the configuration requirement information 223 according to the first embodiment of this invention.

The configuration requirement information 223 stores information about system configuration requirements to be fulfilled in order to secure reliability demanded by a user or the like. Examples of information stored in the configuration requirement information 223 include configuration information necessary to implement a given cluster, information that indicates the presence or absence of a heartbeat line in an HA configuration, information that indicates whether or not the heartbeat line is connected directly to a device, and information that indicates whether or not the heartbeat line can be connected via a switch. Also stored are information that indicates the presence or absence of aggregation (whether or not a necessary count of adapters can be secured by disabling aggregation), and information that indicates whether or not a switch and a device, or one device and another device, are coupled in a criss-crossed manner.

Specifically, the configuration requirement information 223 includes an identifier 901, a configuration name 902, and requirements 903.

Stored as the identifier 901 is an identifier for identifying an entry in the configuration requirement information 223. Information that indicates the configuration of a computer system is stored as the configuration name 902.

Concrete configuration requirements of the computer system specified in the configuration name 902 are stored as the requirements 903. Specifically, the requirements 903 include hardware requirements 921, software requirements 922, manager requirements 923, and a priority level 924.

Configuration requirements related to hardware in the computer system are stored as the hardware requirements 921. Examples of what is stored as the hardware requirements 921 include information that indicates whether or not a heartbeat line is necessary, information that indicates whether or not the same system and the same device are necessary, information that indicates whether or not shared storage is needed, information about the count of adapters, and information about the method of coupling to another piece of IT equipment.

Configuration requirements related to software in the computer system are stored as the software requirements 922. Examples of what is stored as the software requirements 922 include information that indicates the cluster software type, information that indicates the virtualization part type, information that indicates whether or not a virtual switch is necessary, information that indicates whether or not a dedicated network is necessary, information that indicates the vendor type, and information that indicates whether or not a particular function is supported. This makes it possible to, for example, determine whether or not a cluster configuration can be built based on the information that indicates the vendor type.

Configuration requirements related to a manager in the computer system are stored as the manager requirements 923. Specifically, information that indicates whether or not manager software dedicated to system configuration management is necessary is stored as the manager requirements 923.

The priority level 924 is the same as the priority level 604.

FIG. 10 is an explanatory diagram showing an example of the service management information 224 according to the first embodiment of this invention.

The service management information 224 stores information about a service of a computer system that is run, such as the service type and the software type, settings of the computer system, the priority level of the service, and requirements (a user request or a service request) for the reliability of the computer system.

Specifically, the service management information 224 includes a service identifier 1001, a UUID 1002, a service type 1003, service settings information 1004, and a priority order 1005.

An identifier for identifying a service which is provided by using the virtual servers 420 or the like is stored as the service identifier 1001. The UUID 1002 is the same as the UUID 1002.

Stored as the service type 1003 is information about the service type and software that specifies the service, such as an application and middleware to be used.

Settings information necessary for the service is stored as the service settings information 1004. Examples of what is stored as the service settings information 1004 include a logical IP address that is used in the service, an ID, a password, a disk image, and the port number of a port that is used in the service. The disk image is a disk image of a system disk in which the service before and after setting is deployed to the OS on the active server. Information about a disk image that is stored as the business settings information 1004 may include information of a data disk.

Stored as the priority order 905 are the place in priority order of the service and the specifics of the requirements for reliability. For example, the place in priority order among services and requirements for the service in question are stored as the priority order 1005. A service that is to be executed preferentially can thus be set.

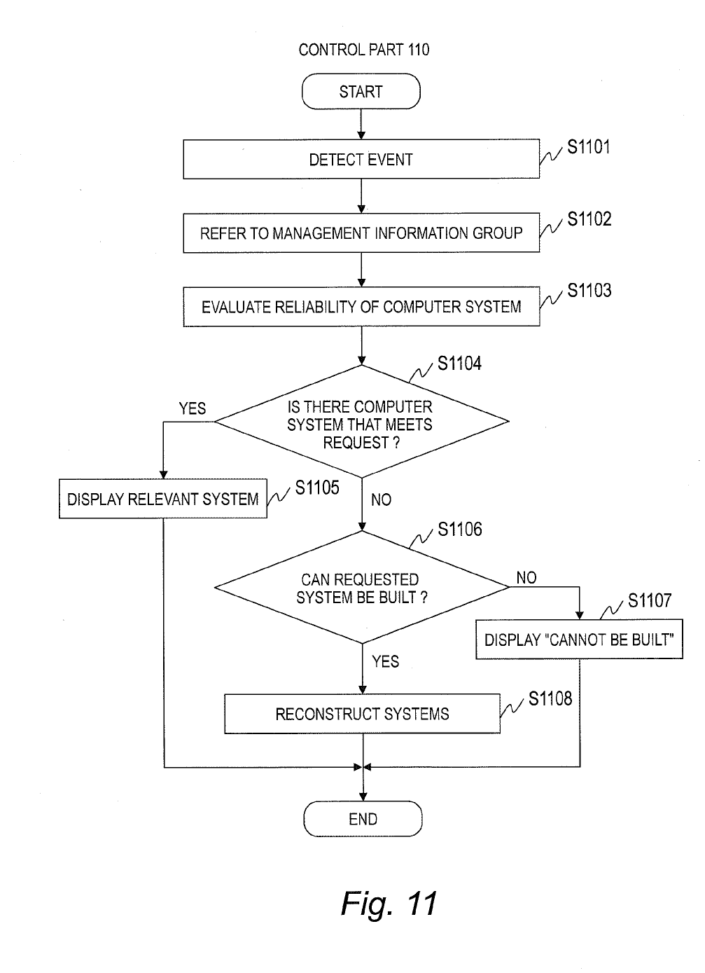

FIG. 11 is a flow chart illustrating processing that is executed by the control part 110 according to the first embodiment of this invention.

The control part 110 starts the processing in a case where an event is detected (Step S1101). Specifically, the event detecting part 210 detects an event that triggers reconstruction of computer systems.

Events that are possibly detected include a user request and an alert for notifying a shortage of computer systems that have a necessary level of reliability. In this invention, any event can be detected as long as the event can be a cause for computer system reconstruction. The event detected in this embodiment is a request made by a user to provide a computer system that fulfills given configuration requirements.

The control part 110 refers to the system management information 220, the system configuration information 221, the connection relationship evaluation information 222, and the configuration requirement information 223 (Step S1102).

The control part 110 evaluates the reliability of a system that fulfills the configuration requirements demanded (Step S1103). Specifically, the following processing is executed.

In a first step, the reliability calculating part 211 refers to the system management information 220 and the system configuration information 221 to grasp the configurations of computer systems included in the management subject system.

In a second step, the reliability calculating part 211 selects one of the computer systems, and calculates an evaluation value for each component of the computer system. Components of a computer system here refer to apparatus that construct the computer system and devices that are included in the apparatus. Specifically, the evaluation value is calculated in a manner described below.

The reliability calculating part 211 refers to the HW configuration 602 of the system management information 220 to check the apparatus configuration of the selected computer system. The reliability calculating part 211 refers to the apparatus 703 of the system configuration information 221 to obtain, for each apparatus, information (entry) about the configuration of the apparatus.

The reliability calculating part 211 further refers to the connection relationship evaluation information 222 based on the properties 705, the coupled device 706, and the reliability type 707 in the obtained entry, and calculates an evaluation value for each device and each apparatus.

The evaluation value calculated in this step is a value indicating reliability that corresponds to the reliability type 707 of the obtained entry.

In a third step, the reliability calculating part 211 calculates an overall evaluation value of the selected computer system. Specifically, the reliability calculating part 211 calculates the sum of the evaluation values of the respective devices and the respective apparatus.

In a fourth step, the reliability calculating part 211 refers to the configuration requirement information 223 to calculate the evaluation value of the requested computer system. Specifically, the evaluation value of the requested computer system is calculated as follows.

The reliability calculating part 211 refers to the configuration requirement information 223 to obtain an entry for the requested computer system.

The reliability calculating part 211 refers to the apparatus/device 802 and the properties 803 in the obtained entry and the connection relationship evaluation information 222 to calculate the evaluation value of the requested computer system. This calculation is performed by the same calculation method that is used in the second step and the third step.

In the case where reliability to be evaluated is specified in advance, the reliability calculating part 211 only needs to calculate a relevant evaluation value. The reliability calculating part 211 may store the calculation result in the memory 202. In this way, when an evaluation value is needed, the control part 110 can read the calculation result out of the memory 202, thereby reducing the cost of calculation. In this embodiment, the evaluation value of a computer system is stored in the memory 202 in association with the identifier of the computer system.

The reliability calculating part 211 may generate display information for displaying to the administrator the processing result of the first step to the fourth step, namely, the calculated evaluation values.

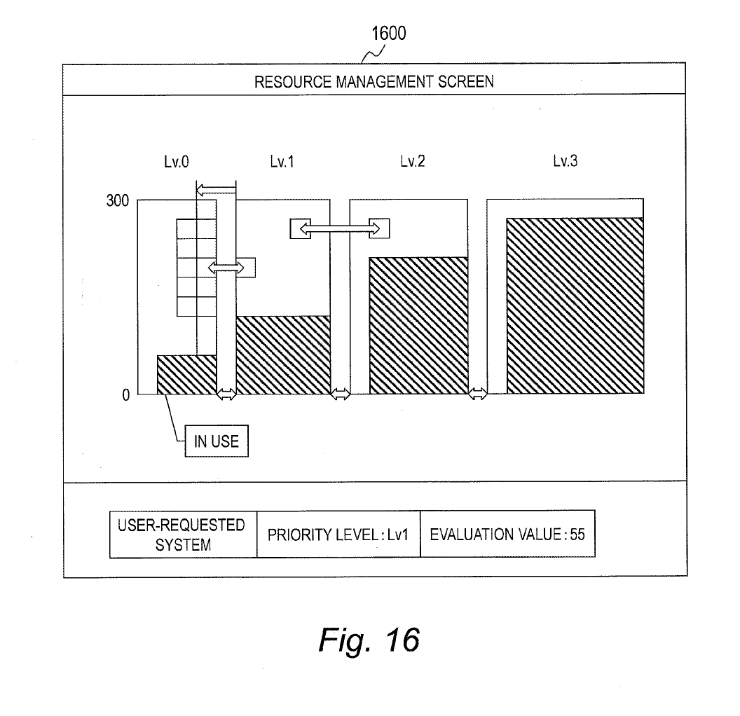

The display part 216 in this case can display the computer system reliability of the currently built computer systems at each priority level based on the generated display information as illustrated in FIG. 16. The display unit 216 displays the priority level and evaluation value of the requested computer system along with the computer system reliability as illustrated in FIG. 16. This enables the administrator to easily determine whether or not the requested computer system can be implemented based on the information displayed on the display part 216.

In this embodiment, the management server 101 determines whether or not a requested computer system can be implemented and changes the configurations of computer systems.

The calculation processing of Step S1103 has now been described.

The control part 110 determines whether or not there is a computer system that fulfills configuration requirements demanded based on the system management information 220 and the configuration requirement information 223 (Step 1104). Configuration requirements include hardware performance, hardware functions, software performance, and the like. Details of Step S1104 are described later with reference to FIG. 12.

In a case where it is determined that there is a computer system that fulfills configuration requirements demanded, the control part 110 displays information about this computer system (Step S1105), and ends the processing.

The display part 216 may display information about a computer system as soon as one computer system that fulfills the requirements is found, or may display computer system information in a list format after all computer systems that fulfill the requirements are found. The display part 216 may also display calculated evaluation values along with the computer system information.

In a case where it is determined that there is no computer system that fulfills configuration requirements demanded, the control part 110 determines whether or not a computer system that fulfills configuration requirements demanded can be built based on the calculated evaluation values (Step S1106). Details of Step S1106 are described later with reference to FIG. 13.

In a case where it is determined that a computer system that fulfills configuration requirements demanded cannot be built, the control part 110 displays a message to the effect that the requested computer system cannot be built (Step S1107), and ends the processing. Specifically, the display part 216 displays a message to the effect that the requested system cannot be built.

In a case where it is determined that a computer system that fulfills configuration requirements demanded can be built, the control part 110 reconstructs computer systems (Step S1108), and ends the processing. Specifically, the configuration changing part 214 reconstructs computer systems. Details of Step S1108 are described later with reference to FIG. 14.

FIG. 12 is a flow chart illustrating processing that is executed by the reliability determining part 212 according to the first embodiment of this invention.

The reliability determining part 212 refers to the system management information 220, the system configuration information 221, and the configuration requirement information 223 (Step S1201) to search for a computer system that matches configuration requirements demanded, or a computer system whose specifications exceed configuration requirements demanded (over spec. computer system) (Step S1202). The search can be performed by the following method.

The reliability determining part 212 compares the value of the priority level 604 and the value of the priority level 924, and searches the system management information 220 for an entry where the value of the priority level 604 matches the value of the priority level 924. The reliability determining part 212 next refers to the system configuration information 221 based on the HW configuration 602 of the found entry to obtain an entry that holds an associated apparatus and device.

Based on the information obtained from the system management information 220 and the information obtained from the system configuration information 221, the reliability determining part 212 determines whether or not the configuration matches, or is an over spec. with respect to, configuration requirements indicated by the requirements 903.

For example, in the case where the system requested by the user is a computer system that has a hot standby function and four servers in which 2-GHz processors each have a core count of 2, the reliability determining part 212 searches for an entry in which “2 GHz” and “core count:2” are written as the properties 605. An entry that stores “3 GHz” and “core count: 4” as the properties 605 is found as an over spec. computer system in this case.

This invention is not limited to the search method described above.

FIG. 13 is a flow chart illustrating processing that is executed by the configuration determining part 213 according to the first embodiment of this invention.

The configuration determining part 213 determines whether or not a system with high reliability is needed (Step S1301). Specifically, the configuration determining part 213 refers to the configuration requirement information 223 to determine whether or not the priority level 924 of the entry for the requested computer system is equal to or more than a given threshold. Here, the threshold is set in advance.

In a case where it is determined that a computer system with high reliability is needed, the configuration determining part 213 searches for computer systems that have low reliability (Step S1302).

Specifically, the configuration determining part 213 refers to the system management information 220 to search for a computer system that has a value smaller than a given threshold as the priority level 604. The threshold can be the same one that is used in Step S1201. The configuration determining part 213 preferentially searches for systems that are not being used for services.

The configuration determining part 213 selects a processing subject computer system from among computer systems found through the search (Step S1303).

Specifically, the configuration determining part 213 selects the computer systems one by one in descending order of the value of the priority level 604, in other words, in ascending order of computer system reliability. In the case where the priority level 604 has the largest value in a plurality of computer systems, the configuration determining part 213 obtains the evaluation values of the respective computer systems to select the computer systems one by one in ascending order of their evaluation values.

The count of computer systems selected at a time is not limited to one, and a plurality of computer systems may be selected depending on configuration requirements demanded.

Computer systems having low reliability are searched for because there is a chance that a system that fulfills configuration requirements demanded can be built by reconstructing computer systems with low reliability.

A computer system selected by the configuration determining part 213 is hereinafter also referred to as subject computer system. A subject computer system selected in Step S1303 is referred to as a first subject computer system, and a subject computer system selected in Step S1312 is referred to as a second subject computer system.

The configuration determining part 213 executes simulation to determine whether a computer system that fulfills configuration requirements demanded can be built by changing the configuration of the first subject computer system (Step S1304).

For example, the configuration determining part 213 changes the type of the coupled device or apparatus repeatedly until an objective device type or apparatus type is reached. The objective device type or apparatus type can be reached efficiently and quickly by starting the search with devices/apparatus that are low in service priority level, that are not in use, and whose reliability type has a low priority level.

The configuration determining part 213 may determine that a computer system that fulfills configuration requirements demanded can be built in a case where there is a computer system that fulfills at least hardware configuration requirements out of configuration requirements demanded. This is because necessary software can be deployed later in the found computer system.

Based on the result of the simulation, the configuration determining part 213 determines whether or not a computer system that fulfills configuration requirements demanded can be built (Step S1305).

In a case where it is determined that the requested computer system cannot be built, the configuration determining part 213 returns to Step S1303 to execute the same processing. The configuration determining part 213 in this case excludes the first subject computer system that has been selected before the return to Step S1303 from selection subjects.

In a case where it is determined that the requested computer system can be built, the configuration determining part 213 calculates the evaluation score of the new computer system (Step S1306). Specifically, the configuration determining part 213 requests the reliability calculating part 211 to calculate the evaluation value of the new computer system by sending information about the new computer system (the simulation result). The evaluation value is calculated by the same method that is used in Step S1103 and a description thereof is omitted.

The configuration determining part 213 determines the configuration of the new computer system based on the calculated evaluation value (Step S1307), and ends the processing. In the case where there are a plurality of computer system candidates, for example, the following approach can be taken.

The configuration determining part 213 selects a system that has the highest evaluation value of the computer system candidates. Alternatively, the display part 216 displays information with “excuse” to the user, who then selects based on the displayed information. “Excuse” is information such as “the system can be built if a heartbeat line is configured via a switch”. The display part 216 may display an evaluation value for each reliability type. The display part 216 may also display information that indicates the influence of the reconstruction of the system.

The configuration determining part 213 generates information necessary for the computer system reconstruction and outputs the generated information to the configuration changing part 214.

In a case where it is determined in Step S1301 that a system with high reliability is not needed, in other words, a computer system with low reliability is needed, the configuration determining part 213 searches for computer systems that have high reliability (Step S1312).

Specifically, the configuration determining part 213 refers to the system management information 220 to search for a computer system that has a value equal to or larger than a given threshold as the priority level 604. The threshold can be the same one that is used in Step S1301. The search can be performed by a method that is substantially the same as the one used in Step S1302, except that computer systems having a redundancy configuration, namely, computer systems with high reliability, are preferentially searched for.

The configuration determining part 213 selects a processing subject computer system from among computer systems found through the search (Step S1313).

Specifically, the configuration determining part 213 selects the computer systems one by one in descending order of the value of the priority level 604, in other words, in ascending order of computer system reliability. In the case where the priority level 604 has the largest value in a plurality of computer systems, the configuration determining part 213 obtains the evaluation values of the respective computer systems to select the computer systems one by one in ascending order of their evaluation values. This is in order to secure computer systems with high reliability as successfully as possible.

The count of computer systems selected at a time is not limited to one, and a plurality of computer systems may be selected depending on configuration requirements demanded.

Computer systems having high reliability are searched for because there is a chance that a system that fulfills configuration requirements demanded can be built by disabling the redundancy configuration of computer systems with high reliability.

The configuration determining part 213 executes simulation to determine whether a computer system that fulfills configuration requirements demanded can be built by changing the configuration of the second subject resource (Step S1314). Specifically, the configuration determining part 213 determines whether or not a computer system that fulfills configuration requirements demanded can be built by disabling the redundancy configuration of the second subject computer system.

For example, the configuration determining part 213 compares a computer system created after the redundancy configuration of the second subject computer system is disabled against the system that fulfills configuration requirements demanded, and determines whether or not the computer system matches, or is an over spec. with respect to, the configuration requirements demanded. The configuration determining part 213 may request the reliability determining part 212 to execute this determination processing.

Based on the result of the simulation, the configuration determining part 213 determines whether or not a computer system that fulfills configuration requirements demanded can be built (Step S1315).

In a case where it is determined that the requested computer system cannot be built, the configuration determining part 213 returns to Step S1313 to execute the same processing. The configuration determining part 213 in this case excludes the second subject computer system that has been selected before the return to Step S1313 from selection subjects.

In a case where it is determined that the requested computer system can be built, the configuration determining part 213 calculates the evaluation score of the new computer system (Step S1306).

The configuration determining part 213 determines the configuration of the new computer system based on the calculated evaluation value (Step S1307), and ends the processing.

In Step S1303 and Step S1313, the display part 216 may display computer systems for each priority level so that the user selects a computer system based on the display. The display part 216 in this case may display evaluation values along with the computer systems.

FIG. 14 is a flow chart illustrating processing that is executed by the configuration changing part 214 according to the first embodiment of this invention.

The configuration changing part 214 builds a new computer system based on the processing result of the configuration determining part 213 (Step S1401). The configuration changing part 214 in this embodiment builds a new computer system by combining a plurality of apparatus and devices, or builds a plurality of computer systems by disabling the redundancy configuration of a computer system.

For example, in the case of building a computer system that has a hot standby function, the configuration changing part 214 configures a cluster from a plurality of servers 102 based on the processing result of the configuration determining part 213, and sets necessary settings in the respective servers 102. In the case of building a computer system that needs aggregation of NICs, the configuration changing part 214 sets settings necessary for aggregation in a plurality of NICs.

The method used here for system building is a known technology, and a detailed description thereof is omitted.

The configuration changing part 214 updates the system management information 220, the system configuration information 221, and the configuration requirement information 223 (Step S1402), and ends the processing.

FIG. 15 is a flow chart illustrating processing that is executed by the evaluation value changing part 215 according to the first embodiment of this invention. The evaluation value changing part 215 executes the processing independently of processing that is executed for system reconstruction.

The control part 110 starts the processing in a case where an event is detected (Step S1501). Specifically, the event detecting part 210 detects an event that triggers the changing of evaluation values.

Events that are possibly detected include cyclic events, year passage marking events, the occurrence of a failure, regular maintenance, and metabolic activities of IT systems and facilities. In this embodiment, any event can be detected as long as the event can be a cause for the changing of evaluation values.

The evaluation value changing part 215 refers to the system management information 220, the system configuration information 221, the connection relationship evaluation information 222, and the configuration requirement information 223 (Step S1502). The evaluation value changing part 215 recalculates evaluation values of apparatus and devices (Step S1503). For example, the evaluation value changing part 215 recalculates evaluation values based on a given algorithm. Different algorithms may be used for different apparatus and different devices.

The evaluation value changing part 215 updates the system management information 220, the system configuration information 221, the connection relationship evaluation information 222, and the configuration requirement information 223 (Step S1504), and ends the processing.

FIG. 16 is an explanatory diagram illustrating an example of a resource management screen according to the first embodiment of this invention.

The display part 216 can display a resource management screen 1600 as illustrated in FIG. 16. In FIG. 16, information on a computer system-by-computer system is displayed.

The control part 110 refers to the pieces of information included in the management information group 111 to grasp the computer system state for each priority level, and generates display information for displaying what is illustrated in FIG. 16. The display part 216 displays the resource management screen 1600 based on the generated display information.

The resource management screen 1600 includes an area for displaying current computer systems and an area for displaying a requested computer system.

The area for displaying current computer systems displays computer system information, such as the count of computer systems and the utilization state of the computer systems, based on priority levels and evaluation values.

In the example of FIG. 16, each system has a priority level displayed in the lateral direction and an evaluation value displayed in the longitudinal direction. The reliability of computer systems can thus be displayed hierarchically. One cell corresponds to one system in the example of FIG. 16. Hatched portions in FIG. 16 represent systems that are actually being used by services.

The area for displaying a requested computer system displays a priority level and an evaluation value.

The administrator of computer systems can determine from which priority level to which priority level resources are to be moved in order to increase/reduce resources by referring to the resource management screen 1600.

While the management server 101 manages a management subject system in the first embodiment, this invention is not limited thereto and the server 102 that is included in a management subject system may have the control part 110 and the management information group 111.

### Second Embodiment

A second embodiment of this invention describes an example of reconstructing systems by disabling NIC aggregation and thus dividing aggregated NICs into a plurality of separate NICs. Here, a user requests a computer system needing a plurality of NICs that are not given redundancy.

In a case where it is determined in Step S1104 that there is no computer system that fulfills configuration requirements demanded by the user, the control part 110 executes the following processing.

The configuration determining part 213 determines in Step S1301 that a system with high reliability is not needed because a system having a plurality of NICs that are not given redundancy is a system with low reliability.

In Step S1312, the configuration determining part 213 searches for a computer system in which NIC aggregation is set.

The configuration determining part 213 determines in Step S1314 and Step S1315 whether or not the requested count of NICs can be secured by disabling the NIC aggregation settings of the found computer system.

In other words, the configuration determining part 213 determines whether or not a computer system that has a necessary count of devices can be built by changing a computer system that has used a plurality of NICs as one NIC logically into a computer system that can use a plurality of NICs individually.

In the case where a sufficient count of computer systems can be secured, a computer system capable of providing a necessary count of devices may be built through reconstruction by integrating a plurality of redundancy configuration computer systems.

In the case of NICs that have a virtual NIC function, the presence or absence of the virtual NIC function is checked as the need arises, and a computer system capable of providing a necessary count of devices may be built through reconstruction by turning on the virtual NIC function.

In the case where a user requests a system in which aggregation is set, on the other hand, the control part 110 uses NICs that do not have a redundancy configuration to build through reconstruction a computer system in which aggregation is set.

### Third Embodiment

A third embodiment of this invention describes an example in which a system that has a heartbeat line is to be built through reconstruction and the heartbeat line is connected via a switch, and an example in which the heartbeat line in the system to be built through reconstruction is connected via switches that have a multi-stage configuration. Here, a user requests a system having a heartbeat line that directly connects devices.

In a case where it is determined in Step S1104 that no system has a heartbeat line that directly connects devices, the control part 110 executes the following processing.

The configuration determining part 213 determines in Step S1301 that a system with high reliability is needed because a system having a heartbeat line is a system with high reliability.

The configuration determining part 213 determines in Steps S1302 to S1305 whether or not a computer system having a heartbeat line that connects via a switch can be built. Here, the configuration determining part 213 determines that this computer system can be built.

In Step S1307, the configuration determining part 213 presents the evaluation values, configuration information, and the like of computer systems that can be built, receives the user's selection, and determines a computer system to be built. The display part 216 may present to the user a fact that “a system close to the demanded reliability level can be built with the use of a heartbeat line that connects via a switch” in this step.

In the case where the heartbeat line connects via multiple stages of switches, the display part 216 presents the configurations of computer systems to the user. The display part 216 in this case may additionally present messages that latency becomes large and the count of points of failure increases.

Because the count of points of failure increases, the reliability calculating part 211 calculates evaluation scores so that the reliability levels of the computer systems drop.

The configuration changing part 214 may adjust the computer systems in which the heartbeat line connects via multiple stages of switches so that the heartbeat interval is long, because of the increased latency in those computer systems. The configuration changing part 214 may also adjust the computer systems conversely so that the heartbeat interval is short, in order to detect a failure early.

### Fourth Embodiment

A fourth embodiment of this invention describes a case in which a user requests a computer system that has the VMware FT configuration or the VMware HA configuration.

In a case where it is determined in Step S1104 that no system has the VMware FT configuration or the VMware HA configuration, the control part 110 executes the following processing.

The configuration determining part 213 determines in Step S1301 that a computer system with high reliability is needed because a system having the VMware FT configuration or the VMware HA configuration is a system with high reliability.

The configuration determining part 213 determines in Steps S1302 to S1305 whether or not a computer system having the VMware FT configuration or the VMware HA configuration can be built by using low-reliability systems. Here, a plurality of computer systems have a priority level equal to or higher than a given level, and as many devices as necessary for the VMware FT configuration or the VMware HA configuration are available.

In Step S1302, the configuration changing part 214 configures a cluster by integrating a plurality of computer systems, and builds a computer system that fulfills configuration requirements demanded by the user by deploying a hypervisor in each server 102.

Computer systems with low reliability may also be built by disabling the VMware FT configuration or the VMware HA configuration and using the resultant systems as a virtualization environment, or by re-deploying another computer system.

### Fifth Embodiment

A fifth embodiment of this invention assumes a case where a user requests a system for migration to the second virtual servers 404.

The control part 110 builds a computer system that has the VMware FT configuration or the VMware HA configuration in a cross configuration. The hypervisor on the first layer builds the VMware FT configuration or the VMware HA configuration between one hypervisor and another hypervisor on the second layer which run on separate pieces of hardware.

The control part 110 utilizes a server in which the first layer is divided physically or logically to localize the influence of a failure, thereby reconstructing computer systems so that the reliability does not drop lower than when virtual servers are utilized.

In a case where a necessary count of systems are not available, the control part 110 secures the necessary count of systems by migration to the same piece of hardware, though the reliability level drops in this case.

According to one embodiment of this invention, the reliability of each computer system can be evaluated as a numerical value by calculating a value that indicates the reliability of the computer system. Resources can therefore be moved automatically between computer systems of different levels of reliability based on the numerical value.

What is claimed is:

1. A computer system, comprising:
at least one computer;
at least one network apparatus;
at least one storage apparatus; and
a plurality of service systems for use in execution of given services,
the at least one computer including at least one first processor, a first memory coupled to the at least one first processor, and a plurality of first I/O devices coupled to the at least one first processor,
the at least one storage apparatus including a second memory, at least one storage medium, and at least one second I/O device for coupled to another apparatus,
the at least one network apparatus including a third memory and at least one port for coupling to another apparatus,
the at least one computer further including a system control part for managing the plurality of service systems,
the system control part being configured to:
hold system configuration information for managing configurations of the plurality of service systems, and evaluation information for managing evaluation values that indicate reliability of the plurality of service systems in the services;
obtain configuration information of the plurality of service systems from the system configuration information, in a case of evaluating the reliability of the plurality of service systems in the services;
calculate the evaluation values of the plurality of service systems based on the obtained configuration information of the plurality of service systems and the evaluation information; and
generate information that indicates the reliability of the plurality of service systems based on the calculated evaluation values.

2. The computer system according to claim 1, wherein the system control part is configured to:
hold configuration requirement information for managing configuration requirements of a service system that is requested by a user;
calculate an evaluation value of a requested service system, in a case where a request to allocate a new service system is received from the user;
determine whether there is a service system that fulfills configuration requirements of the requested service system based on the system configuration information and the configuration requirement information; and
change the configurations of the plurality of service systems based on the calculated evaluation value, the system configuration information, and the configuration requirement information, and build the requested service system, in a case where it is determined that no service system fulfills the configuration requirements of the requested service system.

3. The computer system according to claim 2,
wherein a priority level that indicates a level of reliability for each configuration type of the plurality of service systems is defined in the system configuration information and in the configuration requirement information, and
wherein the system control part is configured to:
determine whether a priority level of the requested service system is more than a first threshold, in a case where the configurations of the plurality of service systems are to be changed;
search a service system included in the computer system for the service system whose priority level is less than a second threshold, in a case where it is determined that the priority level of the requested service system is more than the first threshold;
determine whether the requested service system is able to be built by changing the configuration of the searched service system; and
change the configuration of the searched service system to build the requested service system, in a case where it is determined that the requested service system is able to be built.

4. The computer system according to claim 3, wherein the system control part is configured to:
select a service system one by one starting from the service system that has the smallest priority level and that has the lowest reliability based on the evaluation value, in a case where there are two or more the searched service systems whose the priority level are less than the second threshold; and
simulate changes to the configuration of the selected service system.

5. The computer system according to claim 2,
wherein a priority level that indicates a level of reliability for each configuration type of the plurality of service systems is defined in the system configuration information and in the configuration requirement information, and
wherein the system control part is configured to:
determine whether the priority level of the requested service system is more than a first threshold, in a case where the configurations of the plurality of service systems are to be changed;
search a service system included in the computer system for the service system whose priority level is more than a second threshold, in a case where it is determined that the priority level of the requested service system is equal to or less than the first threshold;
determine whether the requested service system is able to be built by changing the configuration of the searched service system; and
change the configuration of the searched service system to build the requested service system, in a case where it is determined that the requested service system is able to be built.

6. The computer system according to claim 5, wherein the system control part is configured to:
select a service system one by one starting from the service system that has the smallest priority level and that has the lowest reliability based on the evaluation value, in a case where there are two or more the searched service systems whose the priority level is more than the second threshold; and
simulate changes to the configuration of the selected service system.

7. The computer system according to claim 2, wherein the system control part displays configuration information of a service system that is to be newly built, in a case of changing the configurations of the searched service system.

8. The computer system according to claim 2, wherein the system control part is configured to:
detect a change triggering event that triggers a change to the evaluation values stored in the evaluation information; and
analyze the detected change triggering event to update the evaluation values stored in the evaluation information.

9. The computer system according to claim 8, wherein the change triggering event includes at least one of an event that occurs in given cycles, a failure in one of the plurality of service systems, scheduled maintenance of the plurality of service systems, or a change to the configuration of one of the plurality of service systems.

10. A resource management method for a computer system,
the computer system including:
at least one computer;
at least one network apparatus;
at least one storage apparatus; and
a plurality of service systems for use in execution of given services,
the at least one computer including at least one first processor, a first memory coupled to the at least one first processor, and a plurality of first I/O devices coupled to the at least one first processor,
the at least one storage apparatus including a second memory, at least one storage medium, and at least one second I/O device for coupling to another apparatus,
the at least one network apparatus including a third memory and at least one port for coupling to another apparatus,
the at least one computer further including a system control part for managing the plurality of service systems,
the system control part being configured to hold system configuration information for managing configurations of the plurality of service systems, and evaluation information for managing evaluation values that indicate reliability of the plurality of service systems in the services,
the resource management method including:
a first step of obtaining, by the system control part, configuration information of the plurality of service systems from the system configuration information, in a case of evaluating the reliability of the plurality of service systems in the services;
a second step of calculating, by the system control part, the evaluation values of the plurality of service systems based on the obtained configuration information of the plurality of service systems and the evaluation information; and
a third step of generating, by the system control part, information that indicates the reliability of the plurality of service systems based on the calculated evaluation values.

11. The resource management method according to claim 10,
wherein the system control part holds configuration requirement information for managing configuration requirements of a service system that is requested by a user, and
wherein the resource management method further includes:
a fourth step of calculating, by the system control part, an evaluation value of a requested service system, in a case where a request to allocate a new service system is received from the user;
a fifth step of determining, by the system control part, whether there is a service system that fulfills configuration requirements of the requested service system based on the system configuration information and the configuration requirement information; and
a sixth step of changing, by the system control part the configurations of the plurality of service systems based on the calculated evaluation value, the system configuration information, and the configuration requirement information, and building the requested service system, in a case where it is determined that no service system fulfills the configuration requirements of the requested service system.

12. The resource management method according to claim 11,
wherein a priority level that indicates a level of reliability for each configuration type of the plurality of service systems is defined in the system configuration information and in the configuration requirement information, and
wherein the sixth step includes:
a seventh step of determining, by the system control part, whether a priority level of the requested service system is more than a first threshold;
an eighth step of searching, by the system control part, a service system included in the computer system for the service system whose priority level is less than a second threshold, in a case where it is determined that the priority level of the requested service system is more than the first threshold;
a ninth step of determining, by the system control part, whether the requested service system is able to be built by changing the configuration of the searched service system; and
a tenth step of changing, by the system control part, the configuration of the searched service system to build the requested service system, in a case where it is determined that the requested service system is able to be built.

13. The resource management method according to claim 12,
wherein the eighth step includes selecting a service system one by one starting from the service system that has the smallest priority level and that has the lowest reliability based on the evaluation value, in a case where there are two or more the searched service systems whose the priority level are less than the second threshold, and
wherein the ninth step includes simulating changes to the configuration of the selected service system.

14. The resource management method according to claim 11,
wherein a priority level that indicates a level of reliability for each configuration type of the plurality of service systems is defined in the system configuration information and in the configuration requirement information, and
wherein the resource management method further includes:
an eleventh step of determining, by the system control part, whether the priority level of the requested service system is more than a first threshold, in a case where the configurations of the plurality of service systems are to be changed;
a twelfth step of searching, by the system control part, a service system included in the computer system for the service system whose priority level is more than a second threshold, in a case where it is determined that the priority level of the requested service system is equal to or less than the first threshold;
a thirteenth step of determining, by the system control part, whether the requested service system is able to be built by changing the configuration of the searched service system; and
a fourteenth step of changing, by the system control part, the configuration of the searched service system to build the requested service system, in a case where it is determined that the requested service system is able to be built.

15. The resource management method according to claim 14,
wherein the twelfth step includes selecting a service system one by one starting from the service system that has the smallest priority level and that has the lowest reliability based on the evaluation value, in a case where there are two of more the searched service systems whose the priority level is more than the second threshold, and
wherein the thirteenth step includes simulating changes to the configuration of the selected service system.

16. The resource management method according to claim 11, wherein the sixth step includes displaying configuration information of a service system that is to be newly built, in a case of changing the configurations of the searched service system.

17. The resource management method according to claim 11, further including:
detecting, by the system control part, a change triggering event that triggers a change to the evaluation values stored in the evaluation information; and
analyzing, by the system control part, the detected change triggering event to update the evaluation values stored in the evaluation information.

18. The resource management method according to claim 17, wherein the change triggering event includes at least one of an event that occurs in given cycles, a failure in one of the plurality of service systems, scheduled maintenance of the plurality of service systems, or a change to the configuration of one of the plurality of service systems.

19. A management computer for managing resources in a computer system,
the computer system including:
at least one computer;
at least one network apparatus;
at least one storage apparatus;
a plurality of service systems for use in execution of given services,
the at least one computer including at least one first processor, a first memory coupled to the at least one first processor, and a plurality of first I/O devices coupled to the at least one first processor,
the at least one storage apparatus including a second memory, at least one storage medium, and at least one second I/O device for coupling to another apparatus,
the at least one network apparatus including a third memory and at least one port for including to another apparatus,
the management computer including a system control part for managing the plurality of service systems,
the management computer being configured to:
hold system configuration information for managing configurations of the plurality of service systems, and evaluation information for managing evaluation values that indicate reliability of the plurality of service systems in the services;
obtain configuration information of the plurality of service systems from the system configuration information, in a case of evaluating the reliability of the plurality of service systems in the services;
calculate the evaluation values of the plurality of service systems based on the obtained configuration information of the plurality of service systems and the evaluation information; and
generate information that indicates the reliability of the plurality of service systems based on the calculated evaluation values.

20. The management computer according to claim 19, wherein the management computer is configured to:
hold configuration requirement information for managing configuration requirements of a service system that is requested by a user;
calculate an evaluation value of a requested service system, in a case where a request to allocate a new service system is received from the user;
determine whether there is a service system that fulfills configuration requirements of the requested service system based on the system configuration information and the configuration requirement information; and
change the configurations of the plurality of service systems based on the calculated evaluation value, the system configuration information, and the configuration requirement information, and build the requested service system, in a case where it is determined that no service system fulfills the configuration requirements of the requested service system.
